(19) United States
(12) Patent Application Publication
(10) Pub. No.: US 2013/0028307 A1
(43) Pub. Date: Jan. 31, 2013

(54) ADAPTIVE MODULATION AND CODING SCHEME ADJUSTMENT IN WIRELESS NETWORKS

(71) Applicants: Hong Ren, Ottawa (CA); Xixian Chen, Napean (CA); Ping Yu, Napean (CA); Mircea Dumitrescu, Ottawa (CA)

(72) Inventors: Hong Ren, Ottawa (CA); Xixian Chen, Napean (CA); Ping Yu, Napean (CA); Mircea Dumitrescu, Ottawa (CA)

(73) Assignee: RESEARCH IN MOTION LIMITED, WATERLOO (CA)

(21) Appl. No.: 13/616,552

(22) Filed: Sep. 14, 2012

Related U.S. Application Data
(63) Continuation of application No. 13/394,754, filed on Jul. 23, 2012.
(60) Provisional application No. 61/242,552, filed on Sep. 15, 2009.
(60) Provisional application No. 61/242,557, filed on Sep. 15, 2009.

(51) Int. Cl. H04B 17/00

(52) U.S. Cl. 375/224

(57) ABSTRACT

In a method of adjusting a modulation and coding scheme (MCS) level for a transmission on a communication channel between a base station and a mobile terminal, at the base station: a target value for an error metric is defined; the error metric is measured; an MCS offset based on a degree of deviation of the measurement of the error metric from the target value is determined; an indication of a channel quality measurement for the communication channel is received from the mobile terminal; a pre-adjusted MCS level corresponding to the indication of the channel quality measurement is determined using a fixed mapping between a set of channel quality levels and a corresponding set of MCS levels; an adjusted MCS level is determined by adding the MCS offset to the pre-adjusted MCS level; and the adjusted MCS level is assigned to the transmission.

### RELATED APPLICATIONS

This application claims the benefit of U.S. Provisional Patent Application No. 61/242,552, filed on Sep. 15, 2009, and of U.S. Provisional Patent Application No. 61/242,557, filed on Sep. 15, 2009, the contents of both of which are incorporated by reference herein.

### FIELD OF THE INVENTION

The present invention relates to wireless communications and more particularly to a method and system for selecting a modulation and coding scheme (MCS) for a communication channel in a wireless network.

### BACKGROUND

Wireless communication networks, such as cellular networks, operate by sharing resources among mobile terminals operating in the communication network. As part of the sharing process, resources are allocated by one or more controlling devices within the system. Certain types of wireless communication networks are used to support cell-based high speed services such as those under the Long Term Evolution (LTE) standard of the Third Generation Partnership Project (3GPP). Other standards include the IEEE 802.16 standards (also known as WiMAX), and the IEEE 802.11 standards (also known as WiFi).

The 3GPP LTE standard aims to improve the Universal Mobile Telecommunications System (UNITS) terrestrial radio access mobile phone standard to cope with future requirements. The 3GPP LTE technical specification is described in a set of reference documents including LTE; Evolved Universal Terrestrial Radio Access (EUTRA) and Evolved Universal Terrestrial Radio Access Network (E-UTRAN); Overall description; Stage 2: 3GPP TS 36.300 version 9.3.0 Release 9 (2010-04). In 3GPP LTE (E-UTRA and E-UTRAN) terminology, a base station is called an “eNode-B” (eNB) and a mobile terminal or device is called a “user equipment” (UE).

Wireless communications over time-varying radio channels are subject to radio channel impairments such as Additive White Gaussian Noise (AWGN) and fading, which introduce losses in the received information and degrade the quality of the delivered service. To ensure that the required Quality-of-Service (QoS) for a specific application is met under varying radio channel conditions, radio link adaptation techniques become necessary. The ultimate goal of radio link adaptation in wireless communication systems is to attain the required quality of service (QoS) in a particular connection—for example, a downlink (DL) from the base station to the mobile terminal or terminal unit, or, uplink (UL) from the mobile terminal to the base station—with a minimum level of resources.

Conventionally, in link adaptation for the DL and UL channels to a given mobile terminal, the base station may use a Channel Quality Indicator (CQI) value associated with the mobile terminal to schedule resources for data transmission including selecting an appropriate modulation and coding scheme (MCS) level for the data transmission. The CQI value is a function of DL channel quality measurements performed by the mobile terminal on pilot signals transmitted from the base station, such as the signal-to-noise ratio (SNR), the signal-to-interference-plus-noise ratio (SINR), the received signal strength (RSS), the signal-to-noise ratio (SNR), the bit-error-rate (BER) before or after the channel decoder, etc. The CQI value may be periodically updated by the base station based on channel quality reports received on the UL from the mobile terminal. A report may consist of a CQI value, or information sufficient to enable the base station to determine a CQI value for the reporting mobile station. The base station may thus adapt the MCS level of signals transmitted on the DL and UL channels based on the link quality measurements by mapping the CQI value to an MCS level based on a static CQI-to-MCS mapping table.

For example, in 3GPP LTE, the UE provides a measure of channel quality to the eNB by means of Channel Quality Indicator (CQI) values that are continuously fed back to the eNB on an uplink (UL). The UE determines the CQI values based on channel quality measurements (e.g. SNR, SINR, etc.) made on pilot signals transmitted from the eNB. The CQI values are defined as indexes into a mapping table containing sixteen possible MCS levels, Table 1 shows a CQI-to-MCS mapping table used in LTE, reproduced from Table T2.3-1 LTE; Evolved Universal Terrestrial Radio Access (E-UTRA); Physical layer procedures (3GPP TS 36.213 version 9.2.0 Release 9).

TABLE 1
4-bit CQI Table

| CQI index | modulation | code rate × 1024 | efficiency |
|---|---|---|---|
| 0 | out of range | | |
| 1 | QPSK | 78 | 0.1523 |
| 2 | QPSK | 120 | 0.2344 |
| 3 | QPSK | 193 | 0.3770 |
| 4 | QPSK | 308 | 0.6016 |
| 5 | QPSK | 449 | 0.8770 |
| 6 | QPSK | 602 | 1.1758 |
| 7 | 16QAM | 378 | 1.4766 |
| 8 | 16QAM | 490 | 1.9141 |
| 9 | 16QAM | 616 | 2.4063 |
| 10 | 64QAM | 466 | 2.7305 |
| 11 | 64QAM | 567 | 3.3223 |
| 12 | 64QAM | 666 | 3.9023 |
| 13 | 64QAM | 772 | 4.5234 |
| 14 | 64QAM | 873 | 5.1152 |
| 15 | 64QAM | 948 | 5.5547 |

A drawback of the foregoing link adaptation scheme is that a fixed CQI-to-MCS mapping is not expected to always be accurate in the presence of varying channel conditions, since the estimated CQI value may sometimes be too aggressive or too conservative. One may try to address this problem by using different CQI-to-MCS mapping tables when channel conditions change, however this approach would require multiple tables and complicated processing to determine when the table should be changed and which table should be used, leading to suboptimal performance.

Additionally, UEs from different vendors may have different levels of channel estimation accuracy, which may lead to suboptimal MCS levels being used.

Static offsets for adjusting the MCS level in a given CQI-to-MCS mapping table can be used in order to compensate for CQI estimation error. However, if the offsets are determined based on the worst case scenario (e.g. handover region), they can be too conservative for other cases, causing significant performance degradation, such as lower throughput. Conversely, if the offsets are not determined based on the worst case scenario, the worst cases may suffer performance degradation, such as call drops, handover failure and lower throughput.

A need exists for an improved radio link adaptation scheme.

### SUMMARY OF THE INVENTION

In accordance with an aspect of the present invention, there is provided a method of adjusting a modulation and coding scheme (MCS) level for a transmission on a communication channel between a base station and a mobile terminal. The method comprises, at the base station: defining a target value for an error metric; measuring the error metric; determining an MCS offset based on a degree of deviation of the measurement of the error metric from the target value; receiving from the mobile terminal an indication of a channel quality measurement for the communication channel; determining a pre-adjusted MCS level corresponding to the indication of the channel quality measurement using a fixed mapping between a net of channel quality levels and a corresponding set of MCS levels; determining an adjusted MCS level by adding the MCS offset to the pre-adjusted MCS level; and assigning the adjusted MCS level to the transmission.

In accordance with a further aspect of the present invention, there is provided a base station in communication with a mobile terminal over a communication channel. The base station comprises a controller configured to; define a target value for an error metric; measure the error metric; determine an MCS offset based on a degree of deviation of the measurement of the error metric from the target value; receive from the mobile terminal an indication of a channel quality measurement for the communication channel; determine a pre-adjusted MCS level corresponding to the indication of the channel quality measurement using a fixed mapping between a set of channel quality levels and a corresponding set of MCS levels; determine an adjusted MCS level by adding the MCS offset to the pre-adjusted MCS level; and assign the adjusted MCS level to a transmission on the communication channel.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

In the figures which illustrate embodiments of the invention by example only,

FIG. 1 is a block diagram of a cellular communication system;

FIG. 2 is a block diagram of an example base station that might be used to implement some embodiments of the present application;

FIG. 3 is a block diagram of an example mobile terminal that might be used to implement some embodiments of the present application;

FIG. 4 is a block diagram of an example relay station that might be used to implement some embodiments of the present application;

FIG. 5 is a block diagram of a logical breakdown of an example OFDM transmitter architecture that might be used to implement some embodiments of the present application;

FIG. 6 is a block diagram of a logical breakdown of an example OFDM receiver architecture that might be used to implement some embodiments of the present application;

FIG. 7 is a flow diagram of a process at the base station of FIG. 2 for adjusting the MCS level for a communication channel between the base station and the mobile terminal of FIG. 3;

FIG. 8 is an exemplary outer loop MCS control algorithm that might be used to implement some embodiments of the present application;

FIGS. 9A and 9B are a further exemplary outer loop MOS control algorithm that might be used to implement some embodiments of the present application; and

FIGS. 10A and 10B are a yet further exemplary outer loop MCS control algorithm that might be used to implement some embodiments of the present application.

### DETAILED DESCRIPTION

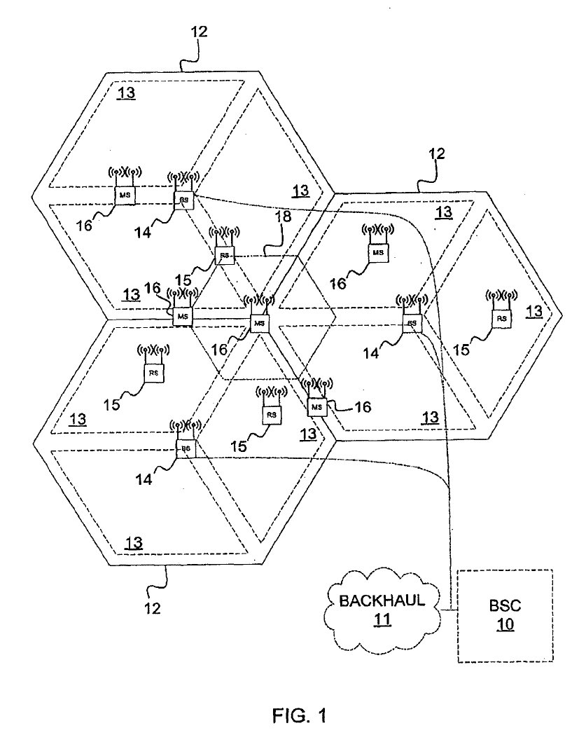

Referring now to the drawing figures in which like reference designators refer to like elements, FIG. 1 shows a base station controller (BSC) 10 which controls wireless communications within multiple cells 12, which cells are served by corresponding base stations (BS) 14. In some configurations, each cell is further divided into multiple sectors 13 (not shown). In general, each base station 14 facilitates communications using OFDM with mobile terminals 16, which are within the cell 12 associated with the corresponding base station 14. The movement of the mobile terminals 16 in relation to the base stations 14 results in significant fluctuation in channel conditions. As illustrated, the base stations 14 and mobile terminals 16 may include multiple antennas to provide spatial diversity for communications. As described in more detail below, relay stations 15 may assist in communications between base stations 14 and mobile terminals 16. Mobile terminals 16 can be handed off 18 from any cell 12, sector 13 (not shown), base station 14 or relay 15 to an other cell 12, sector 13 (not shown), base station 14 or relay 15. In some configurations, base stations 14 communicate with each and with another network (such as a core network or the internet, both not shown) over a backhaul network 11. In some configurations, a base station controller 10 is not needed.

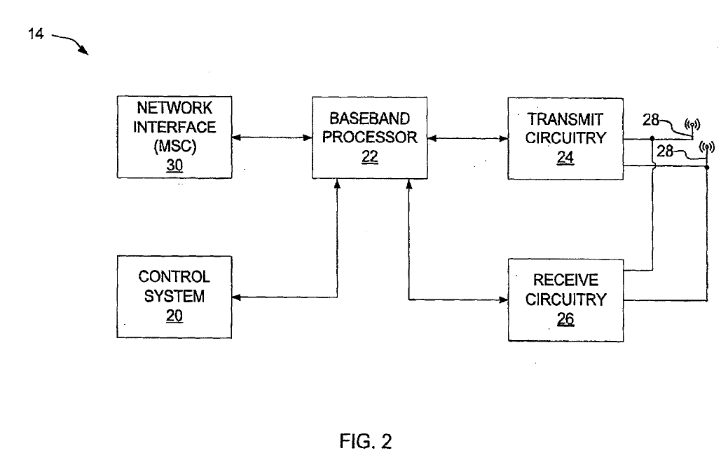

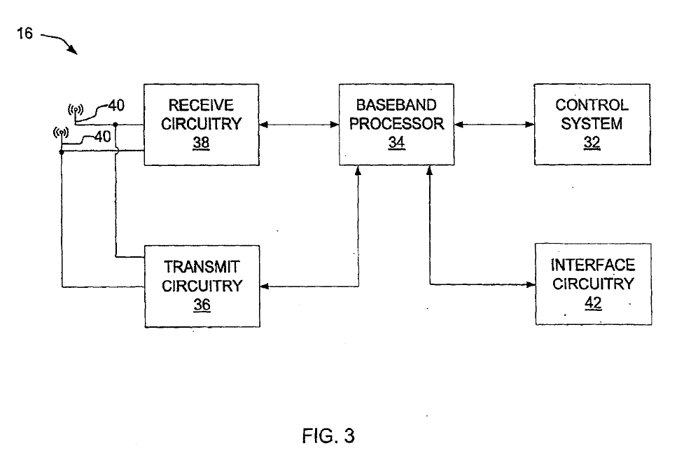

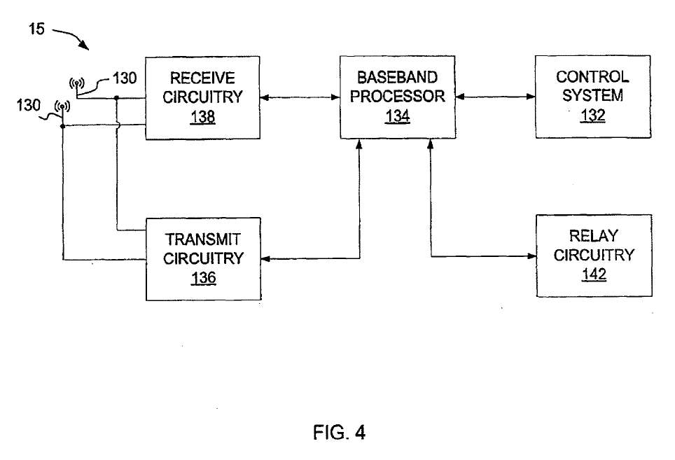

FIG. 2 depicts an example of a base station 14. Base station 14 generally includes a control system 20, a baseband processor 22, transmit circuitry 24, receive circuitry 26, antennas 28, and a network interface 30. The receive circuitry 26 receives radio frequency signals bearing information from one or more remote transmitters provided by mobile terminals 16 (illustrated in FIG. 3) and relay stations 15 (illustrated in FIG. 4). A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

The baseband processor 22 processes the digitized received signal to extract the information or data bits conveyed in the received signal. This processing typically comprises demodulation, decoding, and error correction operations. As such, the baseband processor 22 is generally implemented in one or more digital signal processors (DSPs) or application-specific integrated circuits (ASICs). The received information is then sent across a wireless network via the network interface 30 or transmitted to another mobile terminal 16 serviced by the base station 14, either directly or with the assistance of a relay 15.

On the transmit side, baseband processor 22 receives digitized data, which may represent voice, data, or control information, from the network interface 30 under the control of control system 20, and encodes the data for transmission. The encoded data is output to the transmit circuitry 24, where it is modulated by one or more carrier signals having a desired transmit frequency or frequencies. A power amplifier (not shown) will amplify the modulated carrier signals to a level appropriate for transmission, and deliver the modulated carrier signals to the antennas 28 through a matching network (not shown). Modulation and processing details are described in greater detail below.

FIG. 3 illustrates an example of a mobile terminal 16. Similarly to the base station 14, the mobile terminal 16 will include a control system 32, a baseband processor 34, transmit circuitry 38, receive circuitry 38, antennas 40, and user interface circuitry 42. The receive circuitry 38 receives radio frequency signals bearing information from one or more base stations 14 and relays 15. A low noise amplifier and a filter (not shown) may cooperate to amplify and remove broadband interference from the signal for processing. Downconversion and digitization circuitry (no(shown) will then downconvert the filtered, received signal to an intermediate or baseband frequency signal, which is then digitized into one or more digital streams.

Baseband processor 34 processes the digitized received signal to extract the information or data bits conveyed in the received signal. This processing typically comprises demodulation, decoding, and error correction operations. The baseband processor 34 is generally implemented in one or more digital signal processors (DSPs) and application specific integrated circuits (ASICs).

For transmission, baseband processor 34 receives digitized data, which may represent voice, video, data, or control information, from the control system 32, which it encodes for transmission. The encoded data is output to the transmit circuitry 36, where it is used by a modulator to modulate one or more carrier signals that is at a desired transmit frequency or frequencies. A power amplifier (not shown) will amplify the modulated carrier signals to a level appropriate for transmission, and deliver the modulated carrier signal to the antennas 40 through a matching network (not shown). Various modulation and processing techniques available to those skilled in the art are used for signal transmission between the mobile terminal and the base station, either directly or via the relay station.

In OFDM modulation, the transmission band is divided into multiple, orthogonal carrier waves. Each carrier wave is modulated according to the digital data to be transmitted. Because OFDM divides the transmission band into multiple carriers, the bandwidth per carrier decreases and the modulation time per carrier increases. Since the multiple carriers are transmitted in parallel, the transmission rate for the digital data, or symbols, on any given carrier is lower than when a single carrier is used.

OFDM modulation utilizes the performance of an Inverse Fast Fourier Transform (IFFT) on the information to be transmitted. For demodulation, the performance of a Fast Fourier Transform (FFT) on the received signal recovers the transmitted information. In practice, the IFFT and FFT are provided by digital signal processing carrying out an inverse Discrete Fourier Transform (IDFT) and Discrete Fourier Transform (DFT), respectively. Accordingly, the characterizing feature of OFDM modulation is that orthogonal carrier waves are generated for multiple bands within a transmission channel. The modulated signals are digital signals having a relatively low transmission rate and capable of staying within their respective bands. The individual carrier waves are not modulated directly by the digital signals. Instead, ail carrier waves are modulated at once by IFFT processing.

In one embodiment, OFDM is preferably used for at least downlink transmission from the base stations 14 to the mobile terminals 16. Each base station 14 is equipped with “n” transmit antennas 28 (n>=1), and each mobile terminal 16 is equipped with “m” receive antennas 40 (m>=1). Notably, the respective antennas can be used for reception and transmission using appropriate duplexers or switches and are so labelled only for clarity.

When relay stations 15 are used, OFDM is preferably used for downlink transmission from the base stations 14 to the relays 15 and from relay stations 15 to the mobile terminals 16.

FIG. 4 illustrates an example relay station 15. Similarly to the base station 14, and the mobile terminal 16, the relay station 15 includes a control system 132, a baseband processor 134, transmit circuitry 136, receive circuitry 138, antennas 130, and relay circuitry 142. The relay circuitry 142 enables the relay 14 to assist in communications between a base station 16 and mobile terminals 16. The receive circuitry 138 receives radio frequency signals bearing information from one or more base stations 14 and mobile terminals 16. A low noise amplifier and a filter (not shown) may cooperate to amplify and remove broadband interference from the signal for processing. Downconversion and digitization circuitry (not shown) will then downconvert the filtered, received signal to an intermediate or baseband frequency signal, which is then digitized into one or more digital streams.

Baseband processor 134 processes the digitized received signal to extract the information or data bits conveyed in the received signal. This processing typically comprises demodulation, decoding, and error correction operations. Baseband processor 134 is generally implemented in one or more digital signal processors (DSPs) and application specific integrated circuits (ASICs).

For transmission, baseband processor 134 receives digitized data, which may represent voice, video, data, or control information, from control system 132, which it encodes for transmission. The encoded data is output to the transmit circuitry 136, where it is used by a modulator to modulate one or more carrier signals that is at a desired transmit frequency or frequencies. A power amplifier (not shown) will amplify the modulated carrier signals to a level appropriate for transmission, and deliver the modulated carrier signal to the antennas 130 through a matching network (not shown). Various modulation and processing techniques available to those skilled in the art are used for signal transmission between the mobile terminal and the base station, either directly or indirectly via a relay station, as described above.

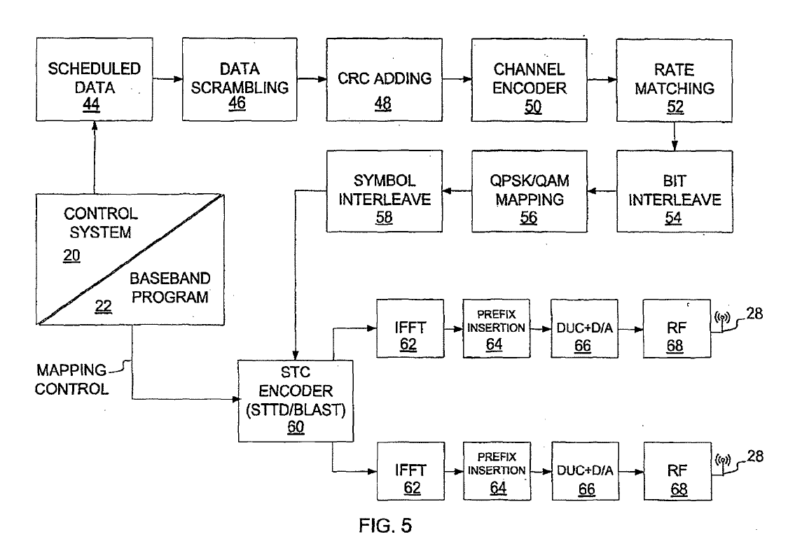

With reference to FIG. 5, a logical OFDM transmission architecture will be described. Initially, base station controller 10 will send data to be transmitted to various mobile terminals 16 to base station 14, either directly or with the assistance of a relay station 15. As described in more detail below, base station 14 uses the channel quality indicators (CQI) values associated with the mobile terminals to schedule the data for transmission as well as select an appropriate modulation and coding scheme (MCS) level for transmitting the scheduled data. The CQI values may be received directly from the mobile terminals 16 or determined at the base station 14 based on information provided by the mobile terminals 16. In either case, the CQI value associated with each mobile terminal 16 may for example be a function of the signal-to-interference ratio (SIR), as well as of the degree to which the channel amplitude (or response) varies across the OFDM frequency band.

Scheduled data 44, which is a stream of bits, is scrambled in a manner reducing the peak-to-average power ratio associated with the data using data scrambling logic 46. A cyclic redundancy check (CRC) for the scrambled data is determined and appended to the scrambled data using CRC adding logic 48. Next, channel coding is performed using channel encoder logic 50 to effectively add redundancy to the data to facilitate recovery and error correction at the mobile terminal 16. As described in more detail below, the channel coding for a particular mobile terminal 16 is based on the current CQI value associated with that mobile terminal In some implementations, the channel encoder logic 50 uses known Turbo encoding techniques. The encoded data is then processed by rate matching logic 52 to compensate for the data expansion associated with encoding.

Bit interleaver logic 54 systematically reorders the bits in the encoded data to minimize the loss of consecutive data bits. The resultant data bits are systematically mapped into corresponding symbols depending on the chosen baseband modulation by mapping logic 56. Preferably, Quadrature Amplitude Modulation (QAM) or Quadrature Phase Shift Key (QPSK) modulation is used. As described in more detail below, the degree of modulation is chosen based on the CQI value for the particular mobile terminal. The symbol may be systematically reordered to further bolster the immunity of the transmitted signal to periodic data loss caused by frequency selective fading using symbol interleaver logic 58.

At this point, groups of bits have been mapped into symbols representing locations in an amplitude and phase constellation. When spatial diversity is desired, blocks of symbols are then processed by space-time block code (STC) encoder logic 60, which modifies the symbols in a fashion making the transmitted signals more resistant to interference and more readily decoded at a mobile terminal 16. The STC encoder logic 60 will process the incoming symbols and provide “n” outputs corresponding to the number of transmit antennas 28 for the base station 14. The control system 20 and/or baseband processor 22 as described above with reference to FIG. 5 will provide a mapping control signal to control STC encoding. At this point, assume the symbols for the “n” outputs are representative of the data to be transmitted and capable of being recovered by the mobile terminal 16.

For the present example, assume the base station 14 has two antennas 28 (n=2) and the STC encoder logic 60 provides two output streams of symbols. Accordingly, each of the symbol streams output by the SIC encoder logic 60 is sent to a corresponding IFFT processor 62, illustrated separately for ease of understanding. Those skilled in the art will recognize that one or more processors may be used to provide such digital signal processing, alone or in combination with other processing described herein. The IFFT processors 62 will preferably operate on the respective symbols to provide an inverse Fourier Transform. The output of the TUFT processors 62 provides symbols in the time domain. The time domain symbols are grouped into frames, which are associated with a prefix by prefix insertion logic 64. Each of the resultant signals is up-converted in the digital domain to an intermediate frequency and converted to an analog signal via the corresponding digital up-conversion (DUG) and digital-to-analog (DIA) conversion circuitry 66. The resultant (analog) signals are then simultaneously modulated at the desired RF frequency, amplified, and transmitted via the RF circuitry 68 and antennas 28. Notably, pilot signals known by the intended mobile terminal 16 are scattered among the sub-carriers. The mobile terminal 16, which is discussed in detail below, will use the pilot signals for channel estimation.

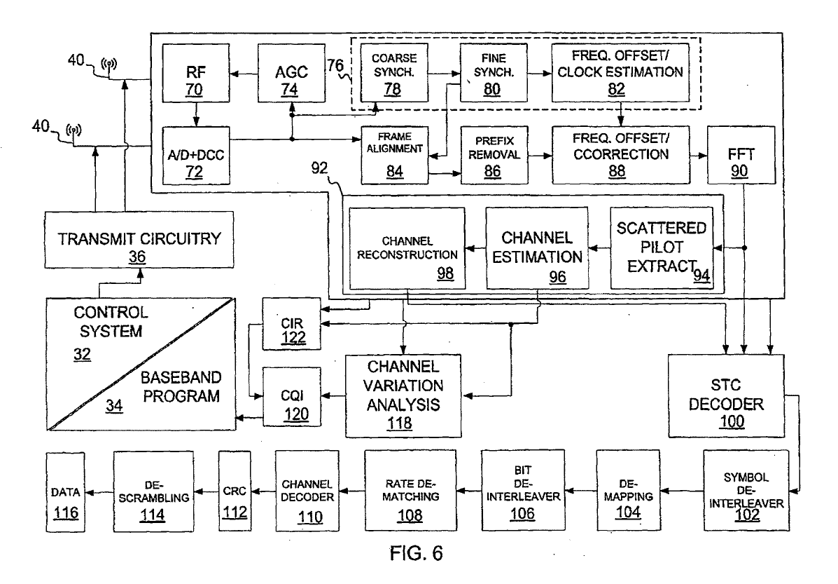

Reference is now made to FIG. 6 to illustrate reception of the transmitted signals by a mobile terminal 16, either directly from base station 14 or with the assistance of relay 15. Upon arrival of the transmitted signals at each of the antennas 40 of the mobile terminal 16, the respective signals are demodulated and amplified by corresponding RF circuitry 70. For the sake of conciseness and clarity, only one of the two receive paths is described and illustrated in detail. Analog-to-digital (AID) converter and down-conversion circuitry 72 digitizes and downconverts the analog signal for digital processing. The resultant digitized signal may be used by automatic gain control circuitry (AGC) 74 to control the gain of the amplifiers in the RF circuitry 70 based on the received signal level.

Initially, the digitized signal is provided to synchronization logic 76, which includes coarse synchronization logic 78, which buffers several OFDM symbols and calculates an auto-correlation between the two successive OFDM symbols. A resultant time index corresponding to the maximum of the correlation result determines a One synchronization search window, which is used by fine synchronization logic 80 to determine a precise framing starting position based on the headers. The output of the fine synchronization logic 80 facilitates frame acquisition by frame alignment logic 84. Proper framing alignment is important so that subsequent PET processing provides an accurate conversion from the time domain to the frequency domain. The fine synchronization algorithm is based on the correlation between the received pilot signals carried by the headers and a local copy of the known pilot data. Once frame alignment acquisition occurs, the prefix of the OFDM symbol is removed with prefix removal logic 86 and resultant samples are sent to frequency offset correction logic 88, which compensates for the system frequency offset caused by the unmatched local oscillators in the transmitter and the receiver. Preferably, the synchronization logic 76 includes frequency offset and clock estimation logic 82, which is based on the headers to help estimate such effects on the transmitted signal and provide those estimations to the correction logic 88 to properly process OFDM symbols.

At this point, the OFDM symbols in the time domain are ready for conversion to the frequency domain using EFT processing logic 90. The results are frequency domain symbols, which are sent to processing logic 92. The processing logic 92 extracts the scattered pilot signal using scattered pilot extraction logic 94, determines a channel estimate based on the extracted pilot signal using channel estimation logic 96, and provides channel responses for all sub-carriers using channel reconstruction logic 98. In order to determine a channel response for each of the sub-carriers, the pilot signal is essentially multiple pilot symbols that are scattered among the data symbols throughout the OFDM sub-carriers in a known pattern in both time and frequency. Continuing with FIG. 6, the processing logic compares the received pilot symbols with the plot symbols that are expected in certain sub-carriers at certain times to determine a channel response for the sub-carriers in which pilot symbols were transmitted. The results are interpolated to estimate a channel response for most, if not all, of the remaining sub-carriers for which pilot symbols were not provided. The actual and interpolated channel responses are used to estimate an overall channel response, which includes the channel responses for most, if not all, of the sub-carriers in the OFDM channel.

The frequency domain symbols and channel reconstruction information, which are derived from the channel responses for each receive path are provided to an STC decoder 100, which provides SIC decoding on both received paths to recover the transmitted symbols. The channel reconstruction information provides equalization information to SIC decoder 100 sufficient to remove the effects of the transmission channel when processing the respective frequency domain symbols. The relay station could act as another base station or as a terminal in the context of this invention.

The recovered symbols are placed back in order using symbol de-interleaver logic 102, which corresponds to the symbol interleaver logic 58 of the transmitter. The de-interleaved symbols are then demodulated or de-mapped to a corresponding bitstream using de-mapping logic 104. The bits are then de-interleaved using bit de-interleaver logic 106, which corresponds to the bit interleaver logic 54 of the transmitter architecture. The de-interleaved bits are then processed by rate de-matching logic 108 and presented to channel decoder logic 110 to recover the initially scrambled data and the CRC checksum. Accordingly, CRC logic 112 removes the CRC checksum, checks the scrambled data in traditional fashion, and provides it to the de-scrambling logic 114 for de-scrambling using the known base station de-scrambling code to recover the originally transmitted data 116.

In parallel to recovering the data 116, a CQI value, or at least information sufficient to determine a CQI value at the base station 14, is determined and transmitted to the base station 14. As noted above, the CQI value may be a function of the signal-to-interference ratio (SIR), as well as the degree to which the channel response varies across the various sub-carriers in the OFDM frequency band. For this embodiment, the channel gain for each sub-carrier in the OFDM frequency band being used to transmit information is compared relative to one another to determine the degree to which the channel gain varies across the OFDM frequency band. Although numerous techniques are available to measure the degree of variation, one technique is to calculate the standard deviation of the channel gain for each sub-carrier throughout the OFDM frequency band being used to transmit data.

FIGS. 1 to 6 provide one specific example of a communication system that could be used to implement embodiments of the application. It is to be understood that embodiments can be implemented with communications systems having architectures that are different than the specific example, but that operate in a manner consistent with the implementation of the embodiments as described herein.

As is conventional, base station 14 regularly receives channel quality reports from mobile station 16 and, based on the reports, updates a CQI value associated with mobile station 16. The channel quality reports are based on channel quality measurements (e.g. SNR) made by mobile station 16 on pilot signals transmitted from base station 14. Each report may consist of an estimated CQI value, or information sufficient to enable base station 14 to determine a CQI value.

As previously noted, base station 14 maps the CQI value associated with each mobile terminal 16 to a corresponding MCS level using a static mapping table such as the one shown in Table 1, above. However, since the CQI value for any given mobile terminal 16 as assessed by the mobile station may be too aggressive or too conservative due to variations in channel conditions or inaccuracy in the mobile station estimate, base station 14 is configured to adjust the mapped MCS level based on a measured Transport Block (TB) error statistic, such as a Block Error Rate (BLER), with a goal of maintaining the TB error statistic around a target value (e.g. a target BLER). The TB error statistic may be measured on channel payload.

This adjustment is referred to herein as the outer loop MCS control. It is assumed that the CQI values associated with the mobile terminals are based on channel quality measurements which do not take the TB error statistic into account.

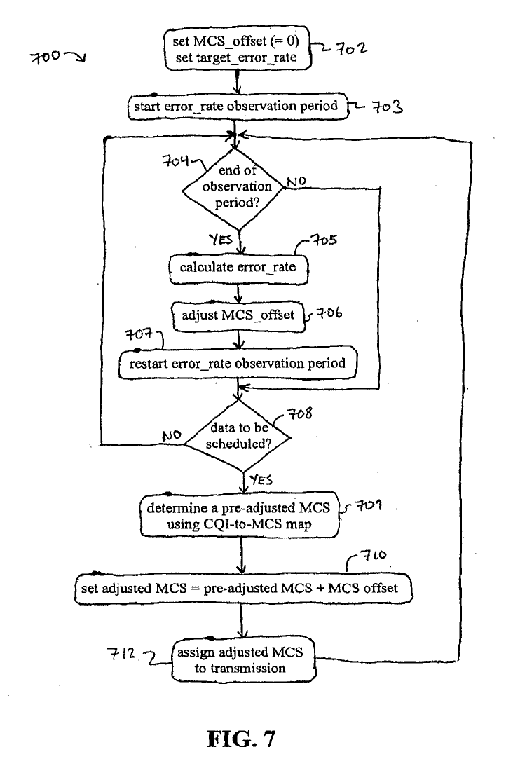

FIG. 7 is a flow diagram illustrating a process 700 at base station 14 for adjusting the MCS level for transmissions on a communication channel (e.g. the DL or UL: channel) between base station 14 and a mobile terminal 16.

As shown, at step 702 an MCS offset and a target error rate are initialized. The MCS offset is an integer value parameter that is used by base station 14 to adjust the MCS level indicated by a given CQI value for mobile terminal 16. More specifically, as previously noted the CQI values may be defined as indexes into a mapping table containing a number of possible MCS levels. The MCS offset is used by base station 14 to adjust the index associated with a given CQI value to thereby provide an adjusted MCS level. MCS offset is preferably initialized to zero. The target error rate represents a target value for a TB error statistic (e.g. a target BLER). It will be appreciated that the target error rate may be defined as a range consisting of an upper threshold and a lower threshold.

At step 703, an observation period for measuring the TB error statistic associated with the payload is started. The observation period may be defined in terms of a specific number of TBs scheduled on the communication channel.

At the end of the observation period (step 704), an error rate is calculated (e.g. a calculated BLER) (step 705), and the MCS offset is adjusted based on the degree of deviation of the calculated error rate from the target error rate (step 706). For example, the MCS offset may be decremented if the calculated error rate exceeds an upper threshold, and it may be incremented if the calculated error rate is below a lower threshold.

In some embodiments, a BLER target may be defined relative to Hybrid Automatic Repeat reQuest (HARQ) termination targets. Specifically, two HARQ termination targets may be implemented: a good TB termination target and a bad TB termination target. Assuming a TB is successfully decoded after n HARQ transmissions, the TB is considered to be a good TB if n<=good termination target while it is considered to be a bad TB if n>=bad TB termination target. Of course, the TB is also considered to be a bad TB if it is not successfully decoded after a maximum number of HARQ transmissions. As is known, in conventional Automatic Repeat reQuest (ARQ) schemes, TB errors are examined at the receiving end by an error detecting code (usually cyclic redundancy check (CRC)). If a TB passes the CRC, the receiving end sends an acknowledgement (ACK) of successful transmission to the receiver. If a TB does not pass the CRC, the receiving end sends a negative acknowledgement (NAK), requesting retransmission. In conventional Hybrid ARQ (HARQ) schemes, user data and its CRC bits are additionally protected by an error correcting code which increases the probability of successful transmission.

In step 707, the observation period is subsequently restarted.

When a TB is to be scheduled for transmission (step 708), base station 14 uses the current CQI value associated with mobile station 16 to determine a corresponding MCS level (the “pre-adjusted MCS lever”) based on a CQI-to-MCS mapping such as the one shown in Table 1, above (step 709). Base station 14 then adjusts the pre-adjusted MCS level by an MCS offset (i.e. adjusted MCS level=pre-adjusted MCS level+MCS offset) (step 710); and assigns the associated adjusted MCS to the transmission (step 712).

As will now be appreciated, process 700 allows adaptive adjustment of a channel modulation and coding scheme, based on both a reported (or calculated) CQI and an error metric of the channel payload. An offset used in adjusting the chosen MCS is itself adaptively adjusted based on the error metric, and thus may account for difference between a reported CQI and the actual channel quality. The offset may be determined and adapted with each transmission.

Process 700 may be performed by base station 14 on a per traffic type basis, where one traffic type (herein referred to as “traffic group”) may contain all data flows that have, for example, the same (or similar) air link error rate and delay requirements. Different traffic groups may be assigned different target error rates and different error rate observation periods. For each traffic group, an MCS offset is calculated and the offset may be used for all MCS levels and for all layers, based on the target error rate that is specific to that traffic. In some embodiments, three traffic groups may be defined: a delay-sensitive group for sensitive traffic such as VoIP, a best effort group for delay insensitive traffic such as E-mail, and a signalling group for control signalling.

Optionally, in the case of the signalling group, rather than dynamically adjust the MCS offset base station 14 may use a configured MCS offset table in order to reduce software complexity and, since the amount of signalling is not expected to be large, the performance degradation is likely to be small.

It will be appreciated that although three traffic groups are described, other traffic classifications may be used with more or fewer traffic groups. In some embodiments, an algorithm may be used which does not distinguish traffic types.

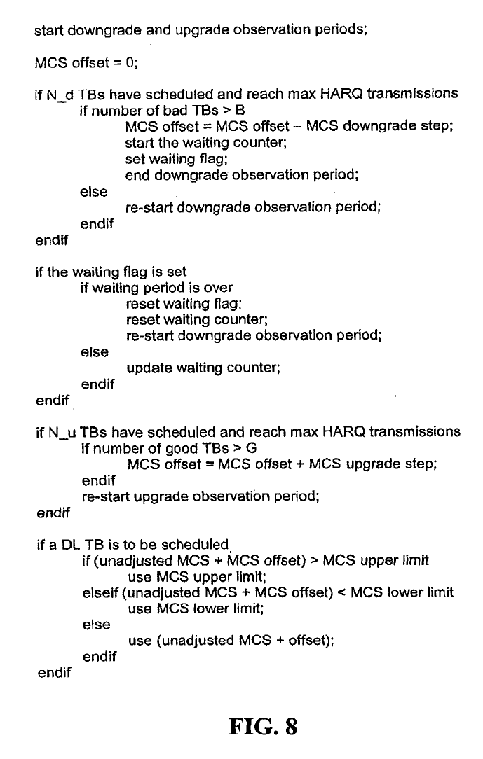

FIG. 8 illustrates in pseudo code an outer loop MCS control algorithm that might be used to implement some embodiments of the present application. The algorithm of FIG. 8 utilizes the following configuration parameters:
Enable/disable flag.
DL HARQ termination target—Each traffic group has a different DL HARQ termination target.
Downgrade observation period (N_d)—The number of Transport Blocks
(TB) to be observed for a downgrade decision. Each traffic group may have a different N_d.
Bad packet threshold (B)—If there are more than B bad TBs among N_d TBs, downgrade MCS. Each traffic group may have a different B.
Upgrade observation period ( N_u)—The number of TBs to be observed for an upgrade decision. Each traffic group may have a different N_u.
Good packet threshold (G)—If there are more than G good TBs among N_U TBs, upgrade MCS. Each traffic group may have a different G.
Waiting period—The period of time in units of milliseconds that eNB waits after downgrading MCS. eNB starts the downgrade observation period after the waiting period. The waiting period allows transmissions that use the old MCS to terminate within the current cycle so that any (or at least most) TBs received in the new cycle are transmitted using the updated MCS.
MOB downgrade step
MCS upgrade step
MOS lower limit
MOS upper limit
MOS offset lower limit
MCS offset upper limit

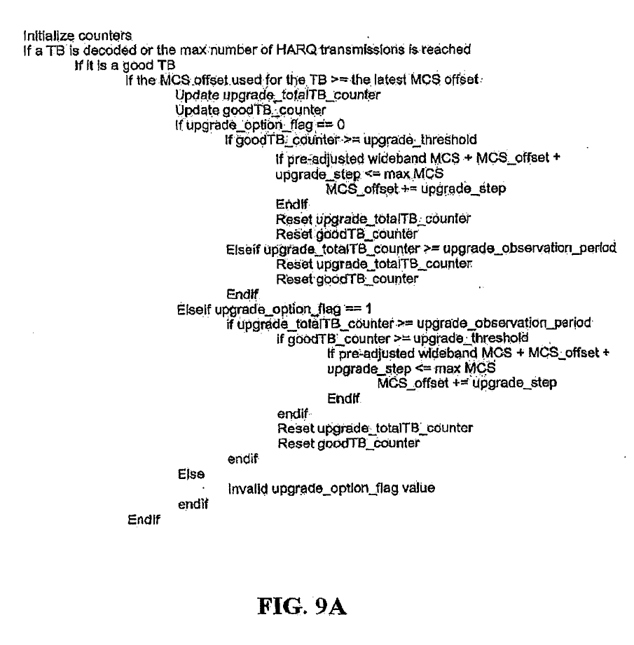

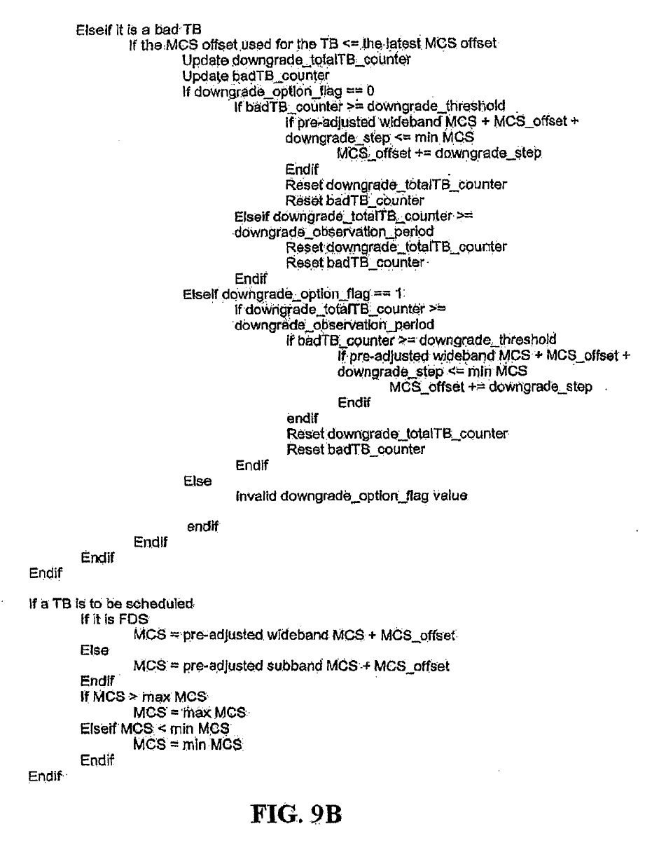

FIG. 9 illustrates in pseudo code another outer loop MCS control algorithm that might be used to implement some embodiments of the present application. As shown, the algorithm of FIG. 9 distinguishes between a wideband MOS and a sub-band MCS according to whether Frequency Division Scheduling (FDS) or Frequency Selective Scheduling (FSS), respectively, is being used. The algorithm of FIG. 9 utilizes the following configuration parameters:
upgrade_observation_period: max number of TBs to be observed for upgrade decision;
upgrade_threshold: if there are upgrade_threshold TBs among upgrade_observation_period or less TBs, a MOS upgrade is triggered;
a upgrade_step: MCS step size for upgrade;
a downgrade_observation_period: max number of TBs to be observed for downgrade decision;
downgrade_threshold: if there are downgrade_threshold TBs among downgrade_observation_period or less TBs, a MCS downgrade is triggered;
downgrade_step: MOS step size for downgrade, it is a negative integer or zero;
downgrade_option_flag: If it is 0, MCS downgrade decision is made as soon as downgrade_threshold bad TBs are observed. If it is 1, MCS downgrade decision is made after downgrade_observation_period TBs are observed.
upgrade_option_flag: If it is 0, MCS upgrade decision is made as soon as upgrade_threshold good TBs are observed. If it is 1. MCS upgrade decision is made after upgrade_observation_period TBs are observed.

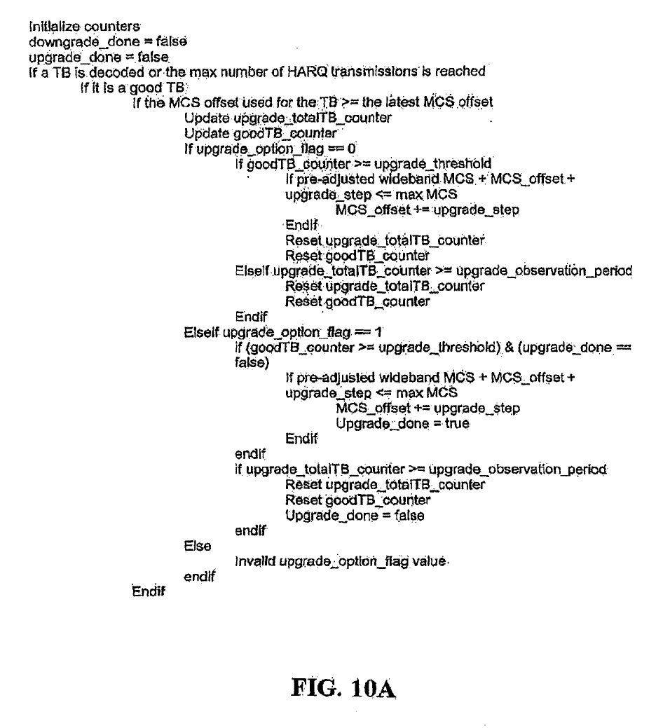

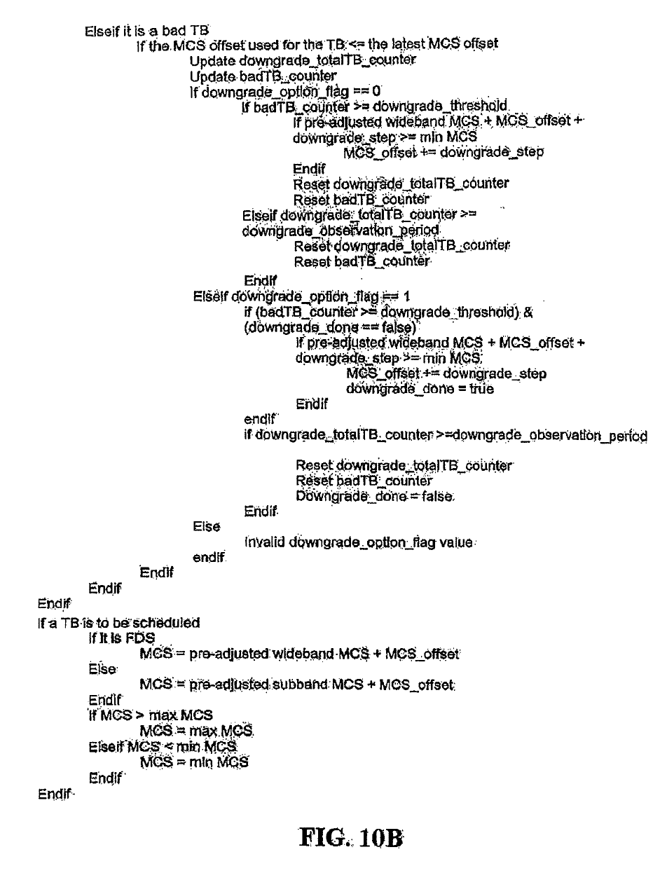

FIG. 10 illustrates in pseudo code yet another outer loop MCS control algorithm that might be used to implement some embodiments of the present application. As shown, the algorithm of FIG. 10 distinguishes between a wideband MCS and a sub-band MCS according to whether Frequency Division Scheduling (FDS) or Frequency Selective Scheduling (FSS), respectively, is being used. The algorithm of FIG. 10 utilizes the following configuration parameters:
upgrade_observation_period: max number of TBs to be observed for upgrade decision;
upgrade_threshold: if there are upgrade_threshold TBs among upgrade_observation_period or less TBs, a MCS upgrade is triggered;
upgrade_step: MCS step size for upgrade;
downgrade_observation_period: max number of TBs to be observed for downgrade decision;
downgrade_threshold: if there are downgrade_threshold TBs among downgrade_observation_period or less TBs, a MCS downgrade is triggered;
downgrade_step: MCS step size for downgrade, it is a negative integer or zero;

downgrade_option_flag: If it is 0, a new downgrade_observation_period is started right after a MCS downgrade or after the previous downgrade_observation_period is over. If it is 1, a new downgrade_observation_period can only be started after the previous downgrade_observation_period is over.
upgrade_option_flag: If it is 0, a new upgrade_observation_period is started right after a MCS upgrade or after the previous upgrade_observation_period is over. If it is a 1, a new upgrade_observation_period can only be started after the previous upgrade_observation_period is over.

In the algorithms shown in FIGS. 9 and 10, for the purpose of simplification the pre-adjusted wideband MOS is used to limit the MCS offset adjustments in all cases. However, it will be appreciated that when limiting the MCS offset adjustments either the pre-adjusted wideband MCS or the pre-adjusted sub-band MCS may be selectively used depending on whether the mobile station is scheduled in FDS or FSS.

In some embodiments, the algorithm is capable of distinguishing packets in order to observe only packets that use the most recently adjusted MCS. Thus, when counting bad TBs for a downgrade decision, if a bad TB was transmitted with a larger MCS offset relative to the latest MCS offset, the bad TB is not counted since it was transmitted before the latest MCS downgrade. Similarly, when counting good TBs for an upgrade decision, if a good TB was transmitted with a smaller MCS offset relative to the latest MCS offset, the good TB is not counted since it was transmitted before the latest MCS upgrade.

An implementation consideration is the length of the waiting period. If the algorithm is capable of distinguishing packets and checks only packets that use the adjusted MCS, the waiting period can be set to zero. If however the algorithm does not distinguish packets and all packets are checked, the waiting period should be set to the minimum size required to ensure that all (or at least most) packets that are checked are transmitted using the adjusted MCS.

Another implementation consideration is when to decide if a packet is good or not. Preferably, the check is performed when an ACK is received or the HARQ termination target is reached, whichever occurs first. Another simple but sub-optimal approach is to check when an ACK is received or when the maximum HARQ transmissions is reached, whichever occurs first.

Other modifications will he apparent to those skilled in the art and, therefore, the invention is defined in the claims.

1-18. (canceled)

19. A method to adjust a modulation and coding scheme (‘MCS’) level for a transmission within a wireless network, the method comprising:
initializing an MCS offset and a target error rate;
starting an observation period for measuring a transport block (‘TB’) error statistic associated with a payload;
calculating an error rate at an end of the observation period;
adjusting the MCS offset based on a degree of deviation of the calculated error rate from the target error rate; and
assigning the adjusted MCS offset to the transmission to facilitate dynamic adjustment of the MCS for transmissions between the wireless network and a mobile terminal.

20. The method of claim 19, further comprising:
determining whether a TB is to be scheduled for transmission from the wireless network to a mobile terminal; and
receiving channel quality indicator (‘CQI’) reports from the mobile terminal.

21. The method of claim 20, wherein determining that the TB is to be scheduled for transmission from the wireless network to a mobile terminal further comprises determining a pre-adjusted MCS level using a CQI-to-MCS mapping.

22. The method of claim 20, wherein determining that the TB is not to be scheduled for transmission from the wireless network to a mobile terminal further comprises repeating the steps of calculating the error rate, adjusting the MCS offset, and determining whether the TB is to be scheduled for transmission from the wireless network to the mobile terminal.

23. The method of claim 19, further comprising updating a CQI value associated with the mobile terminal.

24. The method of claim 19, wherein the MCS offset is an integer value used to adjust an MCS level indicated by a given CQI value for the mobile terminal.

25. The method of claim 19, further comprising determining an adjusted MCS level by adding the adjusted MCS offset to a pre-adjusted MCS level.

26. The method of claim 19, wherein the transport block (‘TB’) error statistic comprises a target block error rate (‘BLER’).

27. The method of claim 26, wherein the target BLER is defined as a range consisting of an upper threshold and a lower threshold.

28. The method of claim 19, wherein adjusting the MCS offset based on the degree of deviation of the calculated error rate from the target error rate further comprises restarting the observation period upon adjusting the MCS offset.

29. A wireless network comprising a processor to adjust a modulation and coding scheme (‘MCS’) level for a transmission, the processor being configured to:
initialize an MCS offset and a target error rate;
start an observation period for measuring a transport block (‘TB’) error statistic associated with a payload;
calculate an error rate at an end of the observation period;
adjust the MCS offset based on a degree of deviation of the calculated error rate from the target error rate; and
assign the adjusted MCS offset to the transmission to facilitate dynamic adjustment of the MCS for transmissions between the wireless network and a mobile terminal.

30. The wireless network of claim 29, the processor is further configured to:
determine whether a TB is to be scheduled for transmission from the wireless network to the mobile terminal; and
receive channel quality indicator (‘CQI’) reports from the mobile terminal.

31. The wireless network of claim 30, wherein determining that the TB is to be scheduled for transmission from the wireless network to a mobile terminal further comprises determining a pre-adjusted MCS level using a CQI-to-MCS mapping.

32. The wireless network of claim 30, wherein determining that the TB is not to be scheduled for transmission from the wireless network to a mobile terminal further comprises the processor configured to repeat the steps of calculating the error rate, adjusting the MCS offset, and determining whether the TB is to be scheduled for transmission from the wireless network to the mobile terminal.

33. The wireless network of claim 29, the processor is further configured to update a CQI value associated with the mobile terminal.

34. The wireless network of claim 29, wherein the MCS offset is an integer value used to adjust an MCS level indicated by a given CQI value for the mobile terminal.

35. The wireless network of claim 29, the processor is further configured to determine an adjusted MCS level by adding the adjusted MCS offset to the pre-adjusted MCS level.

36. The wireless network of claim 29, wherein the transport block (‘TB’) error statistic comprises a target block error rate (‘BLER’).

37. The wireless network of claim 36, wherein the target BLER is defined as a range consisting of an upper threshold and a lower threshold.

38. A method to adjust a modulation and coding scheme (‘MCS’) level in a wireless network, the method at the wireless network comprising:
initializing an MCS offset and a target error rate;
starting an observation period for measuring a transport block (‘TB’) error statistic associated with a payload;
calculating an error rate at an end of the observation period;
adjusting an MCS offset based on a degree of deviation of the calculated error rate from the target error rate; and
determining whether a TB is to be scheduled for transmission from the wireless network to a mobile terminal.
